(19) United States
(12) Patent Application Publication
(10) Pub. No.: US 2014/0005846 A1
(43) Pub. Date: Jan. 2, 2014

(54) SYSTEM AND METHOD FOR CONTROLLING MICRO-GRID OPERATION

(71) Applicants: Jeju National University Industry-Academic Cooperation Foundation, (US); Dae Kyung Engineering Co., Ltd, (US)

(72) Inventors: Chang Jin BOO, Jeju-do (KR); Ho Chan KIM, Jeju-do (KR); Jeong Hyuk KIM, Jeju-do (KR); Su Hyung YANG, Jeju-do (KR); Dae Hwan KIM, Jeju-do (KR); Sin Young KANG, Jeju-do (KR); Sung Eun KANG, Jeju-do (KR)

(73) Assignees: Dae Kyung Engineering Co., Ltd, Jeju-do (KR); Jeju National University Industry-Academic Cooperation Foundation, Jeju-do (KR)

(21) Appl. No.: 13/712,501

(22) Filed: Dec. 12, 2012

(30) Foreign Application Priority Data
Dec. 13, 2011 (KR) KR10-2011-0134565

(51) Int. Cl. G05B 13/02

(52) U.S. Cl. CPC G05B 13/02
USPC 700/291

(57) ABSTRACT

The present application discloses a system for controlling the operation of a microgrid that includes a power unit configured to include a distributed power source including one or more new and renewable energy power sources and to convert the power of the distributed power source and supply the converted power to a load, a load calculation unit configured to calculate an optimal output condition according to the type of load included in a load list in response to the signal of an external power generation source.

### BACKGROUND OF THE INVENTION

1. Technical Field

The present invention relates to integrally controlling the operation of a microgrid and, more particularly, to a system and method for controlling the operation of a microgrid, which can reduce energy through a stable use of power by calculating an optimal output condition according to the type of load and controlling operation mode of the load based on the calculated optimal output condition.

2. Description of the Related Art

In general, a microgrid is a technology and power generation/consumption model for maximizing the economic/technical value of the entire network by utilizing a plurality of distributed power sources installed in a low voltage distribution network.

The microgrid includes a plurality of distributed power sources and an energy storage device. Each of the distributed power sources includes a microturbine, a fuel cell, and a diesel power generator. The distributed power source is relatively slow in a responsive operation characteristic, whereas the energy storage device is relatively fast in a responsive characteristic.

The microgrid configured as above commonly operates in conjunction with an upper system. When a failure occurs in the upper system, the microgrid must separate from the system and perform an independent operation.

That is, the microgrid includes two types of operations: an association operation in which the microgrid operates in conjunction with the upper system and an independent operation in which the microgrid operates independently from the upper system.

Accordingly, when the microgrid performs the association operation, the microgrid has to control power that flows through an association point with the upper system. When the microgrid performs the independent operation, the microgrid has to control a frequency and voltage. For example, if the microgrid operates in conjunction with the upper system, the microgrid maintains a specific frequency by way of the upper system. In the independent operation, however, the microgrid for itself must maintain a specific frequency through control.

In particular, in order for the microgrid to perform proper control in the independent operation, the role of the energy storage device is important. This is because the output of some of a distributed power source cannot be directly controlled (e.g., power generation of solar light and wind power) and the distributed power source has a relatively greater operating time than the energy storage device.

There is only technology for a method of individually controlling a distributed power source and the output of each energy storage device which are applied to a microgrid and for an operation pattern, but there is no technology for controlling operation mode of a microgrid in response to an external request for the use of energy, that is, the execution of an operation for each load type and power control, and achieving energy efficiency and an energy reduction by guaranteeing a stable use of power.

### SUMMARY OF THE INVENTION

Accordingly, an object of the present invention is to economically operate a microgrid and, more particularly, to provide a system and method for controlling the operation of a microgrid, wherein operation mode of the microgrid is performed according to the type of load in the operation of the microgrid that operates in conjunction with a power system, the output of power is subject to a control look-up table in order to control the power and can be stored in the form of the existing data, an update value for a new change value can be set, and the system includes measurement and communication functions and can further include a module for making an independent determination so that a balance can be controlled when a complex power source is included.

Another object of the present invention is to provide a system and method for controlling the operation of a microgrid, which can guarantee a stable use of power and achieve energy efficiency and reduction effects by receiving information on the power state of the entire network from the power network of a power company while operating in conjunction with a main grid, that is, an upper system, calculating an optimal output condition according to the type of load, and controlling operation mode of a load based on the calculated optimal output condition.

In accordance with an aspect of the present invention, a system for controlling the operation of a microgrid includes a power unit configured to include a distributed power source including one or more new and renewable energy power sources and to convert power outputted from the distributed power source and supply the converted power to a load; a load calculation unit configured to calculate an optimal output condition according to the type of load included in a load list in response to a signal received from an external power generation source, determine information on the state of the external power generation source based on the supplied signal, and output a load corresponding to the calculated optimal output condition; an operation mode control unit configured to perform a look-up table on the load outputted from the load calculation unit, output information on the load, and perform power control; and an energy management control unit configured to determine operation mode of the power unit based on the outputted information on the load from the operation mode control unit, control power in the determined operation mode, and control the operation of the power unit using the controlled power.

In accordance with another aspect of the present invention, a method of controlling the operation of a microgrid includes calculating an optimal output condition according to the type of load in response to a signal supplied from an external power generation source; determining information on the state of the external power generation source and outputting a load corresponding to the calculated optimal output condition; performing a look-up table on the outputted load, outputting information on the load, and controlling power control; determining operation mode based on the outputted information on the load and controlling power in the determined operation mode; and controlling an operation using the controlled power.

### BRIEF DESCRIPTION OF THE DRAWINGS

FIG. 1 shows the construction of a system for controlling the operation of a microgrid in accordance with an embodiment of the present invention;

FIG. 2 is a detailed block diagram of a load calculation unit in the system for controlling the operation of a microgrid in accordance with an embodiment of the present invention;

FIG. 3 is a flowchart illustrating a method of controlling the operation of a microgrid in accordance with an embodiment of the present invention;

FIG. 4 is a detailed flowchart illustrating the execution of a load output in the method of controlling the operation of a microgrid in accordance with an embodiment of the present invention;

FIG. 5 is a detailed flowchart illustrating the execution of operation mode determination in the method of controlling the operation of a microgrid in accordance with an embodiment of the present invention; and

FIG. 6 is a detailed flowchart illustrating the execution of operation control in the method of controlling the operation of a microgrid in accordance with an embodiment of the present invention.

### DESCRIPTION OF THE PREFERRED EMBODIMENTS

Hereinafter, some exemplary embodiments of the present invention are described in detail with reference to the accompanying drawings. In the following description, specific items, such as detailed elements, are described and shown. It is however to be noted that the specific items are provided to help a general understanding of the present invention, and it will be evident to those skilled in the art that the specific items can be modified or changed within the scope of the present invention.

The present invention is for economically operating a microgrid. More particularly, the present invention is to provide technology for guaranteeing a stable use of power and achieving energy efficiency and reduction effects, wherein operation mode of a microgrid is performed according to the type of load in the operation of the microgrid that operates in conjunction with a power system, the output of power is subject to a control look-up table in order to control the power and can be stored in the form of the existing data, an update value for a new change value can be set, a system includes measurement and communication functions and can further include a module for making an independent determination so that a balance can be controlled when a complex power source is included, information on the power state of the entire network is received from the power network of a power company in conjunction with a main grid, that is, an upper system, an optimal output condition is calculated according to the type of load, and operation mode of a load is controlled based on the calculated optimal output condition.

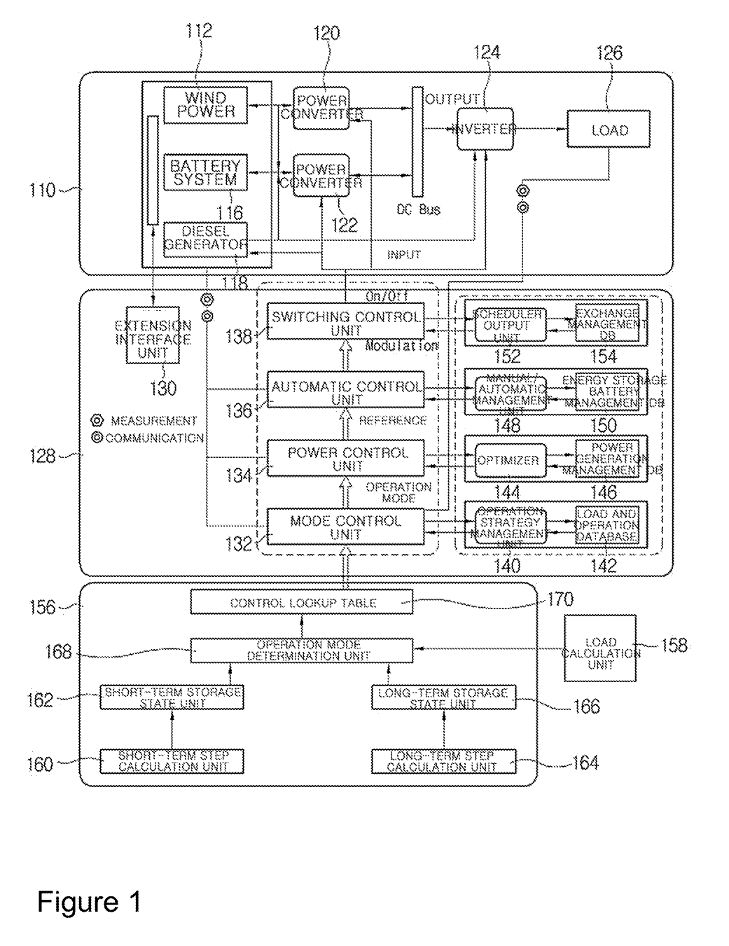

Hereinafter, a system for controlling the operation of a microgrid in accordance with an embodiment of the present invention is described with reference to FIG. 1.

FIG. 1 shows the construction of a system for controlling the operation of a microgrid in accordance with an embodiment of the present invention.

Referring to FIG. 1, the system to which the present invention is applied includes a power unit 110, an energy management control unit 128, an operation mode control unit 156, and a load calculation unit 158.

The power unit 110 includes a distributed power source including one or more new and renewable energy power sources. The power unit 110 converts power outputted from the distributed power source and supplies the converted power to a load 126.

The new and renewable energy power sources include power generation sources for solar light (not shown), wind power 112, a battery 116, and a diesel generator 118. The power of the wind power 112 and the battery 116 is converted into a digital signal in power converters 120 and 122. An inverter 124 according to a characteristic is installed and driven along with the diesel power generator.

Furthermore, the power unit 110 can be configured on the basis of a substation when microgrid technology is applied in association with a commercial system and can be configured as a controllable power generation source when microgrid technology is applied in areas, such as islands where commercial association is difficult.

The load calculation unit 158 calculates an optimal output condition according to the type of load included in a load list in response to a signal supplied from an external power generation source, determines information on the state of the external power generation source based on the supplied signal, and outputs a load corresponding to the calculated optimal output condition.

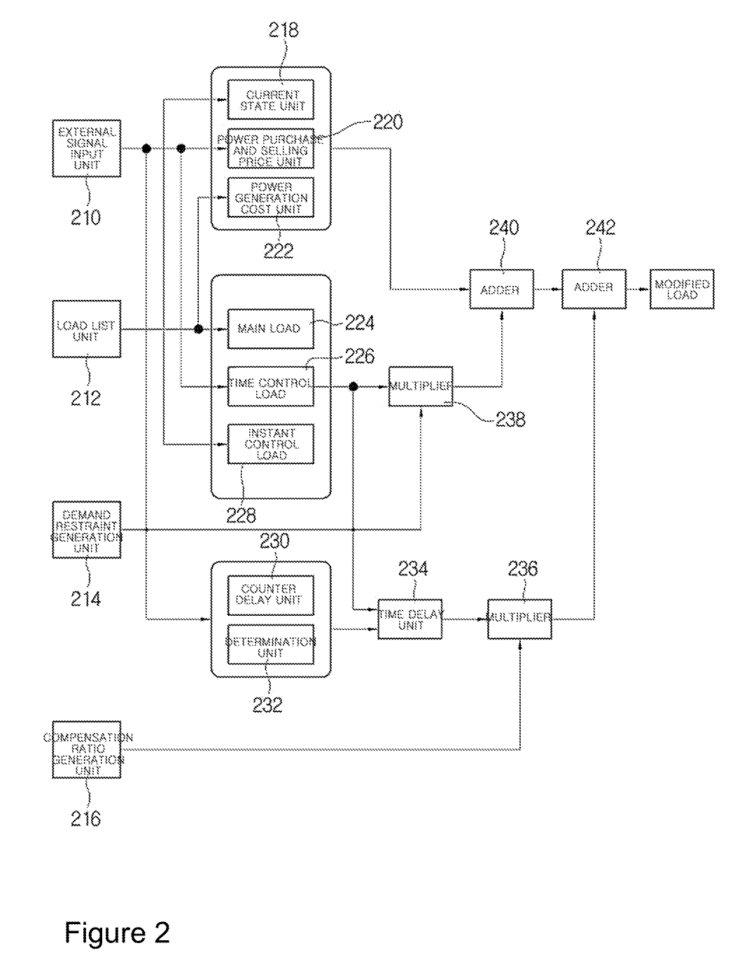

FIG. 2 is a detailed block diagram of a load calculation unit in the system for controlling the operation of a microgrid in accordance with an embodiment of the present invention. Referring to FIG. 2, the load calculation unit includes an external signal input unit 210, a load list unit 212, a demand restraint generation unit 214, and a compensation ratio generation unit 216.

The external signal input unit 210 receives information on the power state of the entire network from the power network of a power company while operating in conjunction with a main grid, that is, an upper system.

The external signal input unit 210 includes a current state unit 218 for receiving a current power generation and load situation of the entire network from the power network of a power company, a power purchase and selling price unit 220 for receiving the power purchase and selling price of the power system, and a power generation cost unit 222 for receiving the cost of power generation of a distributed power source. A signal inputted to the external signal input unit 210 includes information on a power state in which the current power generation and load situation, the power purchase and selling price, and the cost of power generation are incorporated.

The load list unit 212 receives information on the power state from the external signal input unit 210, calculates an optimal output condition using a main load 224, a time control load 226, and an instant control load 228, and outputs the calculated optimal output condition.

The main load 224 is a load that is protected at a minimum when an emergency situation occurs. The main load 224 corresponds to the highest order of priority in the operation of each load. The order of priority of the operation of the time control load 226 can be controlled, and the time control load 226 temporarily stops operating for a predetermined time by taking a short time or a power generation unit cost into consideration. The instant control load 228 corresponds to the lowest order of priority of a load whose operation is forcibly blocked in response to an external signal.

The demand restraint generation unit 214 determines a demand reduction for a load based on information on the power state received from the external signal input unit 210 and controls the output of each load type based on the determined demand reduction. Here, the demand restraint generation unit 214 can represent a demand reduction for a load, and the demand reduction is represented by %. For example, if a value for an important load is 0%, an instant control load can be 100%.

The compensation ratio generation unit 216 determines a compensation ratio for a time control load.

The time control load 226 of the load list unit 212 is controlled so that it performs delay for a specific time through the time delay unit 234 and then performs an operation after processing a power generation unit cost or an emergency operation.

Furthermore, a determination unit 232 determines a situation of the entire network in response to a signal received from the external signal input unit 210, and a counter delay unit 230 determines whether the time has been delayed or not based on the determined situation.

As described above, signals outputted from the external signal input unit 210, the load list unit 212, the demand restraint generation unit 214, and the compensation ratio generation unit 216 are outputted as a load that has been modified in response to an optimal condition through logic circuits, such as multipliers 236 and 238 and adders 240 and 242 corresponding to the characteristics of the corresponding elements.

Referring back to FIG. 1, the operation management control unit 128 performs a look-up table on loads outputted from the load calculation unit, outputs information on the loads, and performs power control.

More particularly, the operation mode control unit 156 performs control so that corresponding time is stored in a short-term storage state unit 162 according to setting by way of a short-term step calculation unit 160, such as a predetermined power generation source from a power company, for example, a short-term operation, such as the drying of a washing machine or the heating of water, and is outputted to an operation mode determination unit 168 and likewise corresponding time is stored in a long-term storage state unit 166 according to setting by way of a long-term step calculation unit 164 for a long-term operation and is outputted to the operation mode determination unit 168. Furthermore, the operation mode control unit 156 controls the operation mode determination unit 168 so that the operation mode determination unit 168 determines operation mode based on a short-term or long-term operation state for a predetermined power generation source from the power company and a modified load outputted from the load calculation unit 158.

Next, a control look-up table unit 170 performs a look-up table the type of load determined by the operation mode determination unit 168.

The energy management control unit 128 includes a mode control unit 132, a power control unit 134, an extension interface unit 130, an automatic control unit 136, and a switching control unit 138.

The mode control unit 132 determines operation mode by performing a comparison on information on a load received from the operation mode control unit 156 with reference to an operation strategy management unit 140 for storing an operation strategy management plan according to the characteristic of a consumer in the target power supply area of the power company and a load and operation database (DB) 142 for storing a load and the type of operation according to the plan of the operation strategy management unit 140.

The power control unit 134 optimizes operation mode outputted from the mode control unit 132 in response to the characteristics of a power generation source by way of an optimizer 144, stores the optimized operation mode in a power generation management DB 146, and then performs power control.

The extension interface unit 130 provides an interface for an added power generation source.

The automatic control unit 136 controls a final output by performing a balance operation on a complex power generation source by distributing a supplied power. The automatic control unit 136 controls a final output through a distribution of new and renewable 70% and diesel 30% for the purpose of an output, for example, 100 by way of a manual/automatic management unit 148 with reference to an energy storage battery management DB 150.

The switching control unit 138 switches on or off the final output of the automatic control unit 136 by way of a scheduler output unit 152 with reference to an exchange management DB 154.

In the system for controlling the operation of a microgrid in accordance with an embodiment of the present invention, the distributed power sources and the loads or pieces of information on the operation state are periodically monitored and collected on-line over the entire network by means of the aforementioned elements. The system for controlling the operation of a microgrid guarantees the use of power by controlling operation mode of a load based on the pieces of information collected on-line.

The construction of the system for controlling the operation of a microgrid in accordance with an embodiment of the present invention has been described above.

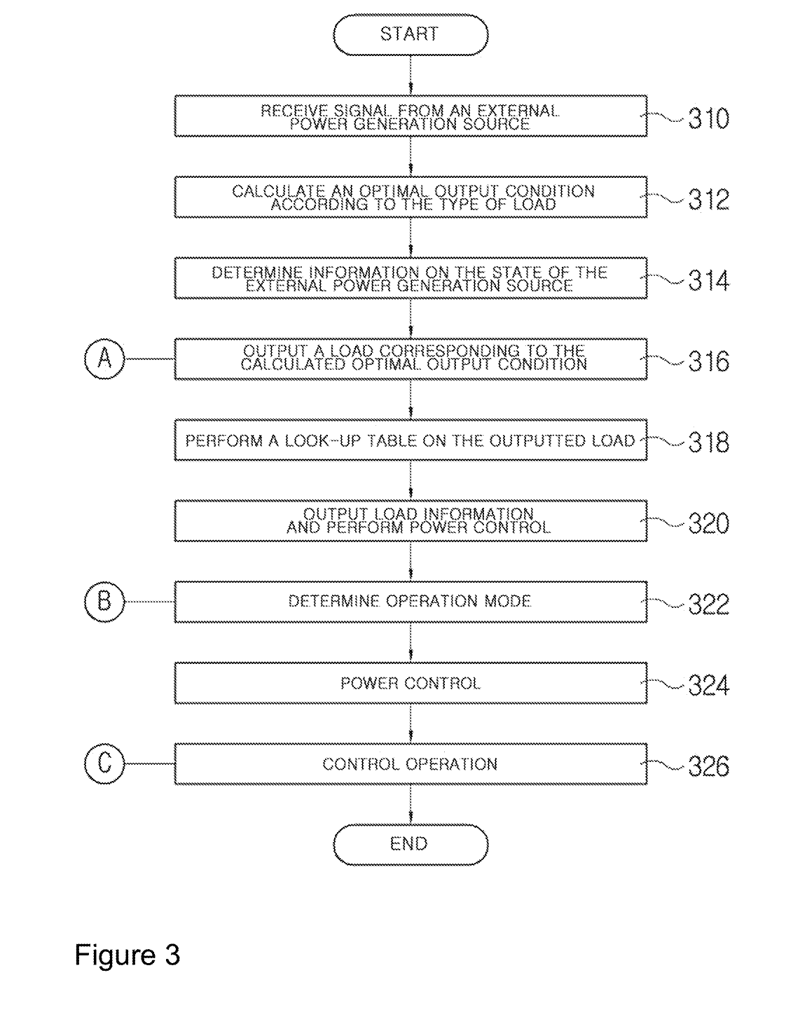

A method of controlling the operation of a microgrid in accordance with an embodiment of the present invention is described in detail with reference to FIGS. 3 to 6.

First, FIG. 3 is a flowchart illustrating a method of controlling the operation of a microgrid in accordance with an embodiment of the present invention.

Referring to FIG. 3, first, after a signal is supplied from an external power generation source at step 310, an optimal output condition according to the type of load is calculated in response to the signal supplied from the external power generation source at step 312.

Information on the state of the external power generation source is determined at step 314, and a load corresponding to the calculated optimal output condition is outputted at step 316.

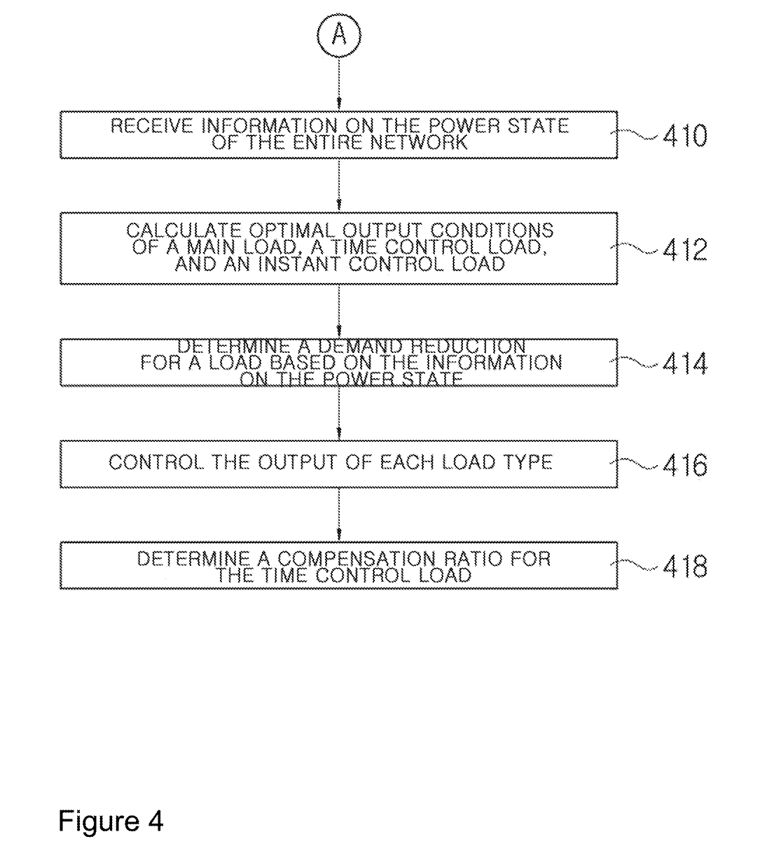

The step 316 is described in more detail below with reference to FIG. 4. In the process of outputting the load, first, information on the power state of the entire network is received from the power network of a power company in association with a main grid, that is, an upper system, at step 410.

Optimal output conditions of the main load, the time control load, and the instant control load are calculated based on the information on the power state and outputted at step 412.

A demand reduction for a load is determined based on the information on the power state at step 414, and the output of each load type is controlled at step 416.

Here, the information on the power state includes information in which a current power generation and load situation of the entire network from the power network of the power company, the power purchase and selling prices of the power system, and the cost of power generation of a distributed power source are taken into consideration.

Next, a compensation ratio for the time control load is determined at step 418.

Referring back to FIG. 3, the load outputted at step 316 is subject to a look-up table at step 318, and information on the load is outputted and power control is controlled at step 320.

Operation mode is determined based on the outputted information on the load at step 322.

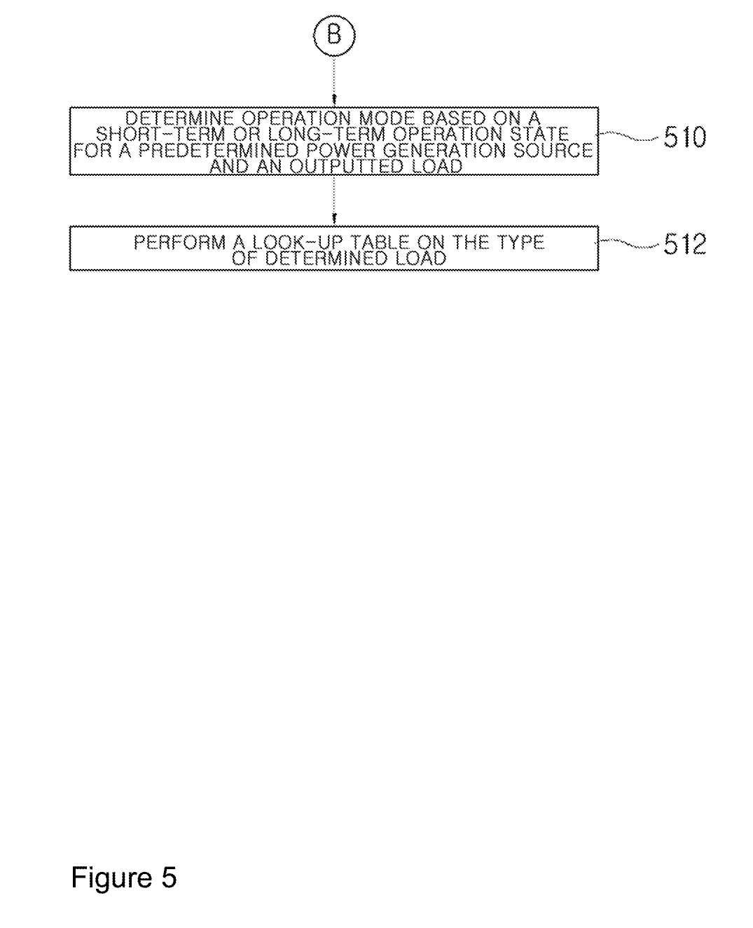

The step 322 is described in more detail below with reference to FIG. 5. Operation mode is determined based on a short-term or long-term operation state for a predetermined power generation source from the power company and the outputted load at step 510, and the type of determined load is subject to a look-up table at step 512.

Referring back to FIG. 3, after the operation is performed, power is controlled in operation mode, determined at step 322, at step 324.

Next, an operation is controlled using the controlled power at step 326.

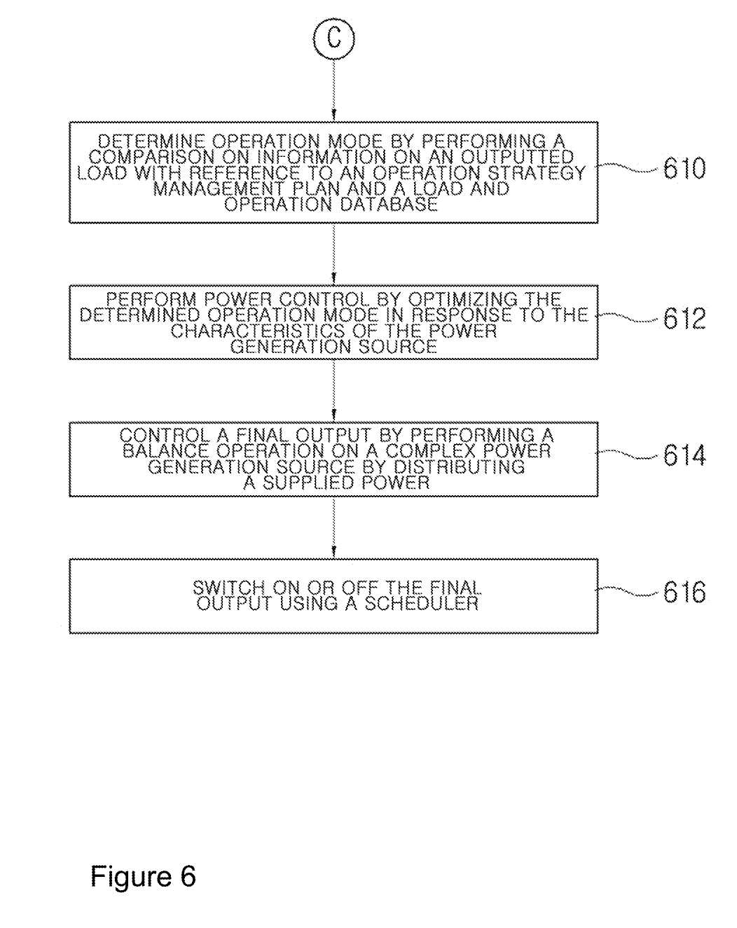

Referring to FIG. 6, the step 326 is performed as follows.

First, at step 610, operation mode is determined by performing a comparison on the information on the outputted load with reference to an operation strategy management plan according to the characteristics of a consumer in the target power supply area of a power company and the load and operation database according to the operation strategy management plan.

Power control is performed by optimizing the determined operation mode in response to the characteristics of the power generation source at step 612. A final output is controlled by performing a balance operation on a complex power generation source by distributing a supplied power at step 614. For example, for an output of 100, the final output is controlled through a distribution of new and renewable 70% and diesel 30%.

At step 616, the scheduler switches on or off the final output.

The system and method for controlling the operation of a microgrid according to the present invention can be operated as described above. Meanwhile, although the detailed embodiments of the present invention have been described, the present invention may be implemented in various manners without departing from the scope of the invention. Accordingly, the scope of the present invention should not be restricted by the aforementioned embodiments, but should be defined by the scope of the appended claims and equivalents thereof.

In accordance with the present invention, information on the power state of the entire network is received from the power network of a power company in association with a main grid, that is, an upper system, an optimal output condition according to the type of load is calculated based on the received information, and operation mode of a load is controlled based on the calculated optimal output condition. Accordingly, there are advantages in that a stable use of power can be guaranteed and energy efficiency and reduction effects can be achieved.

What is claimed is:

1. A system for controlling an operation of a microgrid, comprising:
a power unit configured to comprise a distributed power source comprising one or more new and renewable energy power sources and to convert power outputted from the distributed power source and supply the converted power to a load;
a load calculation unit configured to calculate an optimal output condition according to a type of load included in a load list in response to a signal received from an external power generation source, determine information on a state of the external power generation source based on the supplied signal, and output a load corresponding to the calculated optimal output condition;
an operation mode control unit configured to perform a look-up table on the load outputted from the load calculation unit, output information on the load, and perform power control; and
an energy management control unit configured to determine operation mode of the power unit based on the outputted information on the load from the operation mode control unit, control power in the determined operation mode, and control an operation of the power unit using the controlled power.

2. The system of claim 1, wherein the load calculation unit comprises:
an external signal input unit configured to receive information on a power state of an entire network from a power network of a power company in association with a main grid that is an upper system;
a load list unit configured to receive information on a power state from the external signal input unit, calculate optimal output conditions for a main load, a time control load, and an instant control load, and output the calculated optimal output conditions;
a demand restraint generation unit configured to determine a demand reduction for a load based on the information on the power state received from the external signal input unit, and control an output according to the type of load; and
a compensation ratio generation unit configured to determine a compensation ratio for the time control load.

3. The system of claim 1, wherein the operation mode control unit comprises:
an operation mode determination unit configured to determine the operation mode based on a short-term or long-term operation state for a predetermined power generation source from a power company and a modified load outputted from the load calculation unit; and
a control look-up table unit configured to perform the look-up table on the type of load determined by the operation mode determination unit.

4. The system of claim 1, wherein the energy management control unit comprises:
a mode control unit configured to determine operation mode by performing a comparison on the information on the load received from the operation mode control unit with reference to an operation strategy management unit for storing an operation strategy management plan according to characteristics of a consumer in a target power supply area of a power company and a load and operation database for storing a load and the type of operation according to a plan of the operation strategy management unit;
a power control unit configured to perform power control by optimizing the operation mode outputted from the mode control unit in response to characteristics of the power generation source;
an extension interface unit configured to providing an interface for an added power generation source;
an automatic control unit configured to control a final output by performing a balance operation on a complex power generation source by distributing a supplied power; and
a switching control unit configured to switch on or off the final output outputted from the automatic control unit by way of a scheduler.

5. The system of claim 1, wherein:
the new and renewable energy power sources comprise power generation sources for solar light, wind power, a battery, and a diesel generator, and
each of the power generation sources includes a converter and inverter according to a corresponding characteristic.

6. The system of claim 2, wherein:
the main load is a load protected at a minimum when an emergency situation occurs and the main load corresponds to a highest order of priority in the operation of each load,
the order of priority of the operation of the time control load is controlled and the time control load temporarily stops operating for a predetermined time by taking a short time or a power generation unit cost into consideration, and
the instant control load corresponds to a lowest order of priority of a load whose operation is forcibly blocked in response to an external signal.

7. The system of claim 2, wherein the load calculation unit further comprises:
a time delay unit configured to perform delay for a specific time according to the type of load of the load list, perform processing on a power generation unit cost or an emergency operation, and then perform an operation; and
a counter delay unit configured to determine a situation of an entire network based on a determination of the signal received from the external signal input unit and determine whether or not to delay time.

8. The system of claim 1, wherein the signal supplied from the external power generation source comprises information in which a current power generation and load situation of an entire network from a power network of a power company, power purchase and selling prices of a power system, and a cost of power generation of a distributed power source are taken into consideration.

9. The system of claim 1, wherein:
the distributed power sources and the loads or pieces of information on an operation state are periodically monitored and collected on-line over an entire network, and
the system for controlling the operation of a microgrid guarantees a use of power by controlling operation mode of a load based on the pieces of collected information.

10. A method of controlling an operation of a microgrid, comprising:
calculating an optimal output condition according to a type of load in response to a signal supplied from an external power generation source;
determining information on a state of the external power generation source and outputting a load corresponding to the calculated optimal output condition;
performing a look-up table on the outputted load, outputting information on the load, and controlling power control;
determining operation mode based on the outputted information on the load and controlling power in the determined operation mode; and
controlling an operation using the controlled power.

11. The method of claim 10, wherein outputting a load corresponding to the calculated optimal output condition comprises:
receiving information on a power state of an entire network from a power network of a power company in association with a main grid that is an upper system;
calculating optimal output conditions of a main load, a time control load, and an instant control load based on the information on the power state and outputting the calculated optimal output conditions;
determining a demand reduction for a load based on the information on the power state and controlling an output of each load type; and
determining a compensation ratio for the time control load.

12. The method of claim 10, wherein controlling power in the determined operation mode comprises:
determining the operation mode based on a short-term or long-term operation state for a predetermined power generation source from a power company and the outputted load; and
performing the look-up table on the type of the determined load.

13. The method of claim 10, wherein controlling an operation using the controlled power comprises:
determining the operation mode by performing a comparison on information on the outputted load with reference to an operation strategy management plan according to characteristics of a consumer in a target power supply area of a power company and a load and operation database according to the operation strategy management plan;
performing power control by optimizing the determined operation mode in response to characteristics of the power generation source;
controlling a final output by performing a balance operation on a complex power generation source by distributing a supplied power; and
switching on or off the final output by way of a scheduler.

14. The method of claim 11, wherein:
the main load is a load protected at a minimum when an emergency situation occurs and the main load corresponds to a highest order of priority in the operation of each load,
the order of priority of the operation of the time control load is controlled and the time control load temporarily stops operating for a predetermined time by taking a short time or a power generation unit cost into consideration, and
the instant control load corresponds to a lowest order of priority of a load whose operation is forcibly blocked in response to an external signal.
